(19) United States
(12) Patent Application Publication
(10) Pub. No.: US 2009/0054077 A1
(43) Pub. Date: Feb. 26, 2009

(54) METHOD AND APPARATUS FOR SENDING DATA RELATING TO A TARGET TO A MOBILE DEVICE

(75) Inventors: Claude Gauthier, Richelieu (CA); Martin Kirouac, Brossard (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/949,359

(22) Filed: Dec. 3, 2007

Related U.S. Application Data
(63) Continuation-in-part of application No. 11/843,966, filed on Aug. 23, 2007.

(51) Int. Cl. H04Q 7/20; H04M 1/00

(52) U.S. Cl. 455/456.1; 455/422.1; 455/550.1

(57) ABSTRACT

The invention relates to a method for sending data relating to a target to a mobile device. Upon moving the mobile device to indicate the target, a vector having an origin at the mobile device and a direction pointing toward the target is computed. The vector is sent to a server for identifying the target. Data relating to the target is sent to the mobile device. The mobile device preferably has a location detecting device, a movements measuring system measuring its movements, a logic module computing the vector and first and second communication modules for exchanging data with the server. The server has first and second communications modules for exchanging data with the mobile device and a logic module for identifying the target using the vector and the location of the target.

### PRIORITY

This application is a Continuation In Part (CIP) of U.S. application Ser. No. 11/843,966, filed on Aug. 23, 2007, entitled “System and method for gesture-based command and control of targets in wireless network” to the present inventors, assigned to the assignee of the present invention.

### FIELD OF THE INVENTION

The present invention relates to movement measuring in electronic equipment, and more particularly to a method and apparatus for triggering the sending of data relating to a target to a mobile device.

### BACKGROUND OF THE INVENTION

In today's wireless world, communication is carried out using devices such as mobile phones, desktops, laptops and handhelds to convey information. These devices communicate voice, text and image information by using interfaces such as a microphone, keyboard, notepad, mouse or other peripheral device. While communication technology has developed to a high level, little attention is paid to non-verbal body language, which has been used since time immemorial to communicate information between individuals or groups.

Around the world, gestures play an integral part of communication within every culture. Gestures can communicate as effectively as words, and even more so in some contexts. Examples of gestural language can be seen in traffic police, street vendors, motorists, lecturers, a symphony conductor, a couple flirting, a restaurant patron and a waiter, and athletes and their coaches. It is amazing what the body can communicate expressively and how easily the mind of the observer can almost instinctively process this vocabulary of gestures.

Although there is no prior art as the Applicant's invention, the Patent application publication US 20060017692 generally relates to the field of the present invention. This US publication describes methods and apparatuses for operating a portable device based on an accelerometer. According to one embodiment of the invention, an accelerometer attached to a portable device detects a movement of the portable device. In response, a machine executable code is executed within the portable device to perform one or more predetermined user configurable operations. However, this publication stops short of teaching sending data relating to a target to a mobile device.

Patent application publication US20070149210 also bears some relation with the field of the present invention. This publication describes wireless networks, mobile devices, and associated methods that provide a location-based service to a requesting mobile subscriber. The location-based service allows a requesting mobile subscriber to identify other mobile subscribers in a geographic area, such as in the proximity of the user or another designated area. However, this publication stops short of teaching movement measuring in electronic equipment.

While body-expressed communication is said to account for most communication among humans, current communication technologies make little use of this powerful form of expression.

### SUMMARY

Nothing in the prior art allows the use of movement measured in electronic equipment for triggering the sending of data relating to a target to a mobile device.

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

According to an aspect of the invention, a method for receiving, in a mobile device, data relating to a target comprises the following steps. The first step consists of moving the mobile device to indicate the target. It is followed by a step of computing a vector having an origin at the mobile device and a direction pointing toward the target in response to the moving of the mobile device, a step of sending the vector and a request for the data relating to the target from the mobile device to a server to identify the target and receive data relating to the target and a step of receiving the data relating to the target at the mobile device.

According to another aspect of the invention, a method for triggering a sending of data relating to a target from a server to a mobile device comprises the following steps. First, there is a step of receiving a vector and a request for the data relating to the target from the mobile device, the vector having an origin at the mobile device and a direction pointing toward the target, followed by a step of identifying the target using the vector and a location of the target and finally triggering the sending of the data relating to the target from the server to the mobile device.

According to another aspect of the invention, a mobile device comprises a location detecting device detecting a location of the mobile device. The mobile device also has a movements measuring system measuring movements of the mobile device, a logic module computing a vector having an origin at the location of the mobile device and a direction pointing toward a target, in response to the movements of the mobile device. The mobile device also has a first communication module sending to a server the vector to identify the target and a request for data relating to the target and a second communication module receiving the data relating to the target.

According to another aspect of the invention, a server comprises a first communication module receiving a vector and a request for data relating to a target from a mobile device, the vector having an origin at the mobile device and a direction pointing toward the target. The server also has a logic module receiving the vector from the first communication module and identifying the target using the vector and a location of the target and a second communication module triggering the sending of the data relating to the target identified by the logic module to the mobile device.

### BRIEF DESCRIPTION OF THE DRAWINGS

The objects and advantages of the invention will be understood by reading the following detailed description in conjunction with the drawings in which:

FIG. 1a is an exemplary diagram of a wireless network system in accordance with an exemplary embodiment.

FIG. 1b is an exemplary schematic block diagram of a controlling unit in accordance an embodiment of the invention.

FIG. 2 is an exemplary block diagram of a movement direction and location sensing unit.

FIG. 3 is an exemplary diagram that illustrates reference frames associated with some exemplary embodiments.

FIG. 4 is an exemplary diagram that illustrates a result of separate commands transmitted from a mobile unit to a plurality of receiving units in accordance with an exemplary embodiment.

FIG. 5 is an exemplary diagram illustrating an embodiment of moving and pointing a direction sensing device to identify a targeted mobile unit.

FIG. 6 is an exemplary schematic block diagram of a wireless communication system in accordance with an exemplary embodiment.

FIG. 7 is an exemplary diagram of a suit including sensors and illustrating various pointing angles.

FIG. 8 is an exemplary diagram of a glove including sensing devices in accordance with an embodiment.

FIG. 9 is an exemplary illustration of hand and/or body gestures that may be included in a language set.

FIG. 10 is an exemplary schematic diagram illustrating network-based applications in accordance with some embodiments.

FIG. 11 is an exemplary flowchart illustrating operations for providing at least one command to a remote target according to an embodiment.

FIG. 12 is an exemplary flowchart illustrating operations for indicating a target and receiving data relating to the target in a mobile device.

FIG. 13 is an exemplary flowchart illustrating operations for triggering the sending of data relating to the target from a server to a mobile device.

FIG. 14 is an exemplary flowchart illustrating operations for sending data relating to the target from a server to a mobile device.

FIG. 15 is an exemplary flowchart illustrating operations for sending data where the data is voice data from a communication between two mobile devices.

FIG. 16 is an exemplary block diagram showing components of a mobile device.

FIG. 17 is an exemplary block diagram showing components of a movement measuring system.

FIG. 18 is an exemplary block diagram showing components of a server.

FIG. 19 is an exemplary schematic diagram illustrating network-based applications in accordance with some embodiments.

FIG. 20 is an exemplary schematic diagram illustrating network-based applications in accordance with some embodiments.

FIG. 21 is an exemplary schematic diagram illustrating network-based applications in accordance with some embodiments.

FIG. 22 is an exemplary schematic diagram illustrating network-based applications in accordance with some embodiments.

### DETAILED DESCRIPTION

The various features of the invention will now be described with reference to the figures. These various aspects are described hereafter in greater detail in connection with a number of exemplary embodiments to facilitate an understanding of the invention, but should not be construed as limited to these embodiments. Rather, these embodiments are provided so that the disclosure will be thorough and complete, and will fully convey the scope of the invention to those skilled in the art.

Many aspects of the invention are described in terms of sequences of actions to be performed by elements of a computer system or other hardware capable of executing programmed instructions. It will be recognized that in each of the embodiments, the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention.

In an aspect of embodiments consistent with the invention, gesture language is used as a new way to communicate in a wireless network. Exemplary embodiments involve using gestural actions to identify command and/or control one or more targets in a wireless network. For example, a wireless network may include one or more wireless units that receive directives or other information based on body language conveyed by another wireless unit. Other exemplary embodiments may include gestural identification and control of a target device in a wireless network.

Embodiments according to the present invention are described with reference to block diagrams and/or operational illustrations of methods, mobile units, and computer program products. It is to be understood that each block of the block diagrams and/or operational illustrations, and combinations of blocks in the block diagrams and/or operational illustrations, can be implemented by radio frequency, analog and/or digital hardware, and/or computer program instructions. These computer program instructions may be provided to a processor circuit of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

As used herein, a “mobile unit” or “mobile device” includes, but is not limited to, a device that is configured to receive communication signals via a wireless interface from, for example, a cellular network, a Wide Area Network, wireless local area network (WLAN), a GPS system, and/or another RF communication device. A group of mobile units may form a network structure integrated with other networks, such as the Internet, via cellular or other access networks, or as a stand alone ad-hoc network in which mobile units directly communicate with one another (e.g., peer-to-peer) through one or more signal hops, or combination thereof. Examples of ad-hoc networks include a mobile ad-hoc network (MANET), a mobile mesh ad-hoc network (MMAN), and a Bluetooth-based network, although other types of ad-hoc networks may be used. Exemplary mobile terminals include, but are not limited to, a cellular mobile terminal; a GPS positioning receiver; a personal communication terminal that may combine a cellular mobile terminal with data processing and data communications capabilities; a personal data assistance (PDA) that can include one or more wireless transmitters and/or receivers, pager, Internet/intranet access, local area network interface, wide area network interface, Web browser, organizer, and/or calendar; and a mobile computer or other device that includes one or more wireless transmitters or receivers.

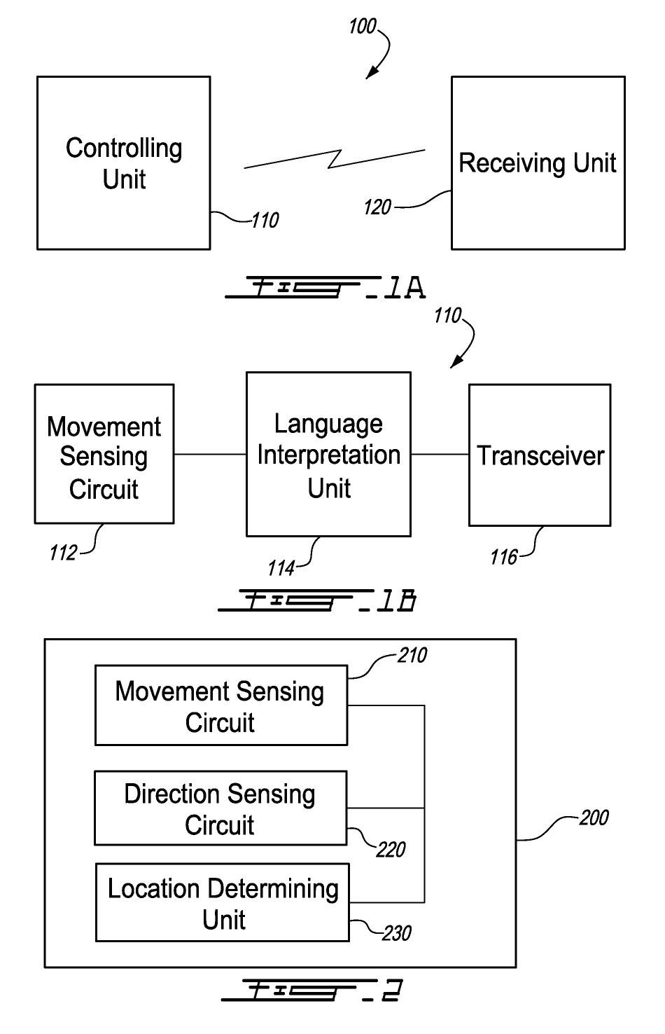

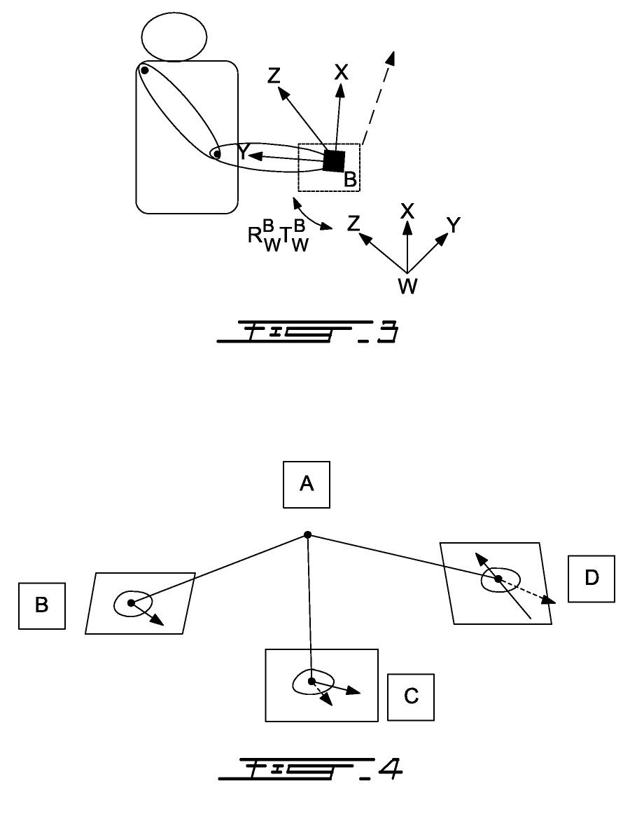

FIG. 1a is a diagram of a wireless network system 100 in accordance with an embodiment of the invention. The wireless network system 100 may include a controlling unit 110 and a receiving unit 140 located remotely from the controlling unit 110. In some embodiments, the controlling unit 110 may be a mobile unit provided with at least one sensor that may detect a series of movements, such as movement of all or part of the controlling unit 110 or a gesture performed by a user of the controlling unit, and distinguish between first and second movement events that respectively identify the targeted receiving unit 120 and command the identified receiving unit 120 to perform an action. In other embodiments, the controlling unit 110 may be a fixed network device (e.g., a computer) located at a node of a wired or wireless network, which may communicate wirelessly with a receiving unit 120 either directly or through an access system (e.g., cellular, WLAN or mesh networks) to identify and control that unit.

FIG. 1b is a schematic block diagram of the controlling unit 110 according to an embodiment of the invention. The controlling unit 110 may include a movement sensing circuit 112 connected to a language interpretation unit 114 by way of a wired or wireless link. The language interpretation unit 114 may include programs that instruct the processor to determine whether an event corresponds to a first movement identifying the receiving unit 120 or a command to be transmitted to the receiving unit 120, although all or some of functions of detecting and determination may be performed with hardware.

The language interpretation unit 114 may identify movements corresponding to elements, or a combination of movements corresponding to a plurality of elements, of a predetermined gestural language set of the network system 100. The gestural language set may include as little as one identification movement and/or one command movement, or as many movements the language interpretation unit 114 is capable of distinguishing and interpreting. Generally, the granularity of the gestural language set corresponds to the precision required for sensing a movement and reliable interpretation of that movement.

The receiving unit 120 may be a fixed device or another mobile unit similar to the controlling unit 110. The receiving unit 120 includes a receiver, which may receive signals transmitted from the controlling unit directly or through one or more hops in a local network (e.g., some WLANs, Bluetooth (BT), MANET), and/or through a wireless access point (e.g., WLAN, cellular or mesh), such as radio network accesses using protocols such as Global Standard for Mobil (GSM) communication Base Station System (BSS), General Packet Radio Services (GPRS), enhanced data rates for GSM evolution (EDGE), code division multiple access (CDMA), wideband-CDMA (WCDMA), although other wireless protocols may be used.

The movement sensing circuit 112 may include one or more sensors, such as an accelerometer, gyroscope, touch pad and/or flex sensor, although other sensors capable of detecting movement may be used. Such sensors may be integrated within, or provided in a peripheral manner with respect to the controlling unit 110. It should be appreciated, however, that a “sensing circuit,” as used herein, may include only one sensor, or a plurality of sensors and related circuitry arranged in a distributed fashion to provide movement information that may be utilized individually or in combination to detect and interpret elements of the gestural language set. In some embodiments, a user of a mobile unit may initiate a movement event in which the sensing circuit 112 receives a plurality of movement language elements provided in a consecutive manner, which identify and command the receiving unit 120. In such a case, the processor may parse the movement event into separate language elements to carry out sequential processing of the elements. In other embodiments, the controlling unit 110 may operate in a mode that will accept a command movement only after receiving acknowledgement from the identified receiving unit 120.

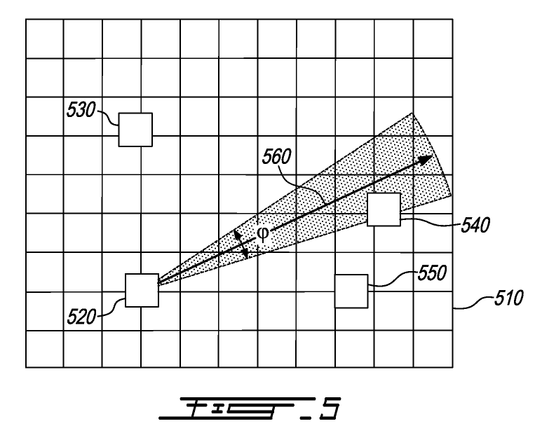

Embodiments of the invention may include a sensor to measure a direction associated with the first movement to identify a particular receiving unit 120. This added dimension is particularly useful when more than one receiving unit 120 is located in proximity of the controlling unit 110. Such embodiments may include a sensing unit 200 shown in block form in FIG. 2. The sensing circuit 200 includes a movement sensing circuit 210, a direction sensing circuit 220, and a location determining unit 230. The movement sensing circuit 210 may include one or more inertial measurement units, such as accelerometers or gyroscopes, although other inertial sensors may be used. The direction sensing circuit 220 may include a direction sensing device, such as an electronic compass, to provide a heading associated with a movement performed by a user of the controlling unit 110 to identify a particular receiving unit 120. The location determining unit 230 includes a location-determining device, such as Global Positioning System (GPS) receiver.

In exemplary embodiments, the heading information may be obtained by pointing a controlling unit 110 in the direction of a receiving unit 120. As used herein, “pointing” may involve a controlling unit 110 that has a direction sensor provided inside a single outer package of the device (e.g., a PDA, cell phone) and moving the entire device to point it at the target. Alternatively, a direction sensing device may be provided in a peripheral manner with respect to other components of the controlling device 110 (e.g., attached to an article of clothing, a body part of the user, a hand-held pointing device, baton, or other manipulable element), and performing a movement to initiate a process of providing a command to a target unit simultaneously with pointing the direction sensor. For example, an embodiment may identify a target by sensing a movement in which an arm is extended fully outward, and a direction sensor attached to the arm, sleeve, finger or glove and oriented along the lengthwise axis of the extended arm, senses the relative direction of the extended arm. In some embodiments, reading a heading may involve moving one body part while pointing with another body part, or performing a sequence of movements (e.g., gesture followed by pointing the direction sensor at the target). However, certain movements may be defined within the gestural language set that would initiate a broadcast command to all receiving devices in the wireless network without utilizing a direction sensor.

As described hereinafter in more detail, the orientation of elements of a direction sensor may provide information permitting calculation of a heading relative to the sensor's orientation. Using the calculated heading to the receiving unit 120, the location information of the controlling unit 110 and receiving unit 120 (e.g., determined via the GPS), the receiving unit 120 may be identified as potential target.

The GPS uses a constellation of 24 satellites orbiting the earth and transmitting microwave band radio frequencies across the globe. GPS receivers capture at least 4 of the satellite transmissions and use difference in signal arrival times to triangulate the receiver's location. This location information is provided in the classic latitude (north-south) and longitude (east-west) coordinates given in degrees, minutes and seconds. While various embodiments of the invention are described herein with reference to GPS satellites, it will be appreciated that they are applicable to positioning systems that utilize pseudolites or a combination of satellites and pseudolites. Pseudolites are ground-based transmitters that broadcast a signal similar to a traditional satellite-sourced GPS signal modulated on an L-band carrier signal, generally synchronized with GPS time. Pseudolites may be useful in situations where GPS signals from orbiting GPS satellites might not be available, such as tunnels, mines, buildings or other enclosed areas. The term “satellite,” as used herein, is intended to include pseudolites or equivalents of pseudolites, and the term GPS signals, as used herein, is intended to include GPS-like signals from pseudolites or equivalents of pseudolites. Also, while the following discussion references the United States GPS system, various embodiments herein can be applicable to similar satellite positioning systems, such as the GLONASS system or GALILEO system. The term “GPS”, as used herein, includes such alternative satellite positioning systems, including the GLONASS system and the GALILEO system. Thus, the term “GPS signals” can include signals from such alternative satellite positioning systems.

Direction may be sensed by a two-axis electronic compass, which measures the horizontal vector components of the earth's magnetic field using two sensor elements in the horizontal plane but orthogonal to each other. These orthogonally oriented sensors are called the X-axis and Y-axis sensors, which measure the magnetic field in their respective sensitive axis. The arc tangent Y/X provides the heading of the compass with respect to the X-axis. A two-axis compass can remain accurate as long as the sensors remain horizontal, or orthogonal to the gravitational (downward) vector. In some mobile embodiments, two-axis compasses may be mechanically gimbaled to remain flat and ensure accuracy. Other embodiments may include a three-axis magnetic compass, which contains magnetic sensors in all three orthogonal vectors of an electronic compass assembly to capture the horizontal and vertical components of the earth's magnetic field. To electronically gimbal this type of compass, the three magnetic sensors may be complemented by a tilt-sensing element to measure the gravitational direction. The tilt sensor provides two-axis measurement of compass assembly tilt, known as pitch and roll axis. The five axis of sensor inputs are combined to create a “tilt-compensated” version of the X-axis and Y-axis magnetic vectors, and then may be computed into a tilt-compensated heading.

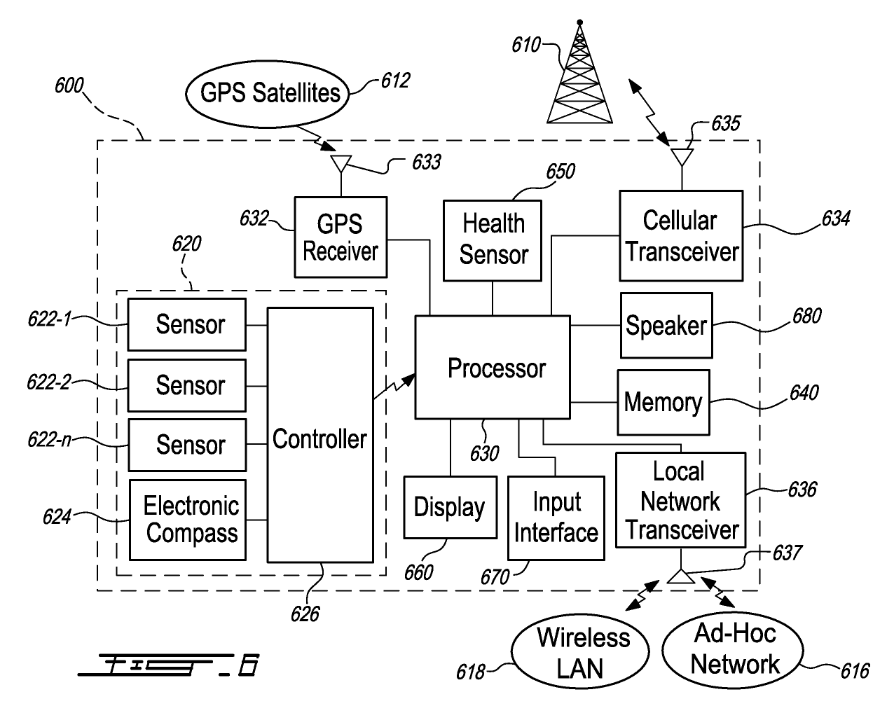

FIG. 3 is a diagram illustrating a reference frame B at the end of a forearm. Sensors may be provided on the forearm to detect and track movements of the arm. For example, a gyroscope device provided on or over the cuff area will move in the same motion as the arm angular movement as it moves up to down and left to right. The gyroscope may be of one or two axis design. Similarly, one, two or three axis acceleration sensors (e.g., accelerometers) may be positioned on or about the arm to obtain acceleration data useful for determining movements involving translation. However, a consideration is the lack of an absolute reference frame and the difficulty of tracking orientation relative to a fixed frame for longer than a few seconds. Therefore, in some embodiments of the invention, an electronic compass can be attached to the body to provide a reference frame.

Information output from the movement sensors, the electronic compass, and a GPS receiver may be analyzed to determine whether a user performed one or more gestures to identify and command a target in the wireless network. For example, FIG. 4 shows how gesture-based language may be used in a local wireless network to individually target and command mobile units. As shown FIG. 4, a mobile unit A points to a mobile unit B and performs a gesture that commands B to “move forward” (e.g., a hand direction). Commands received by B (or any other mobile target) may be played back as a voice and/or text message. Only mobile unit B receives and processes this message. Next, mobile unit A points to a mobile unit D and commands D to “move back.” Again, only mobile unit D would be receiving this information. Next, mobile unit A points to a mobile unit C and commands C to “move forward.” All movement of mobile units B, C and D may be collected and mobile unit A is informed of all new positions.

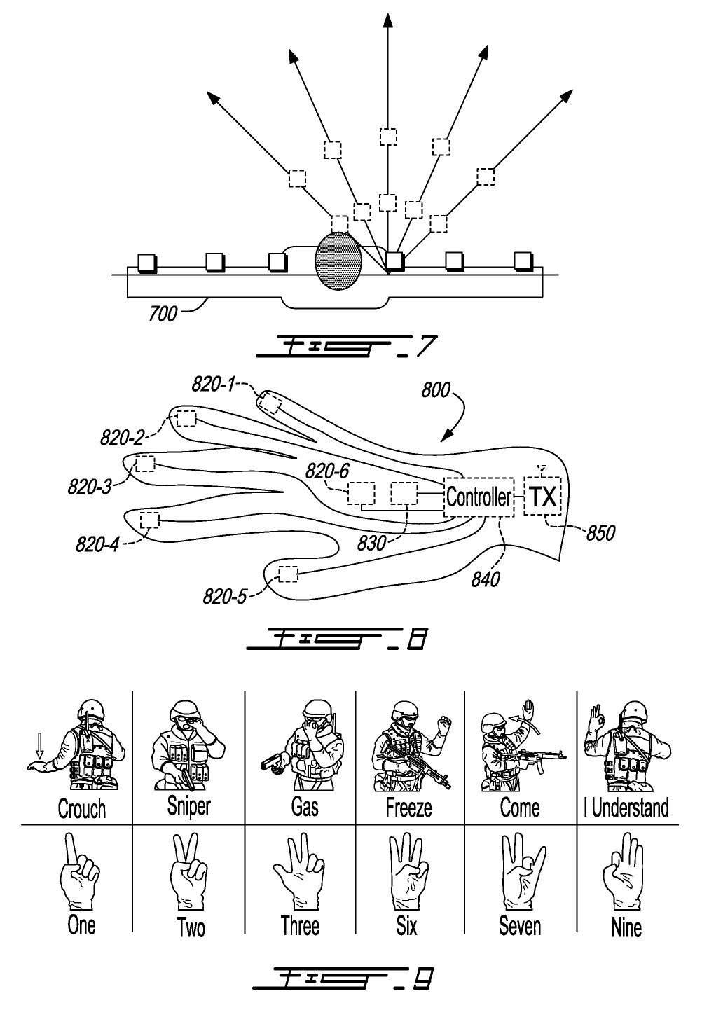

FIG. 5 is a diagram of an embodiment illustrating how a “pointing” movement may identify a target (e.g., a receiving mobile unit). For purposes of explanation, FIG. 5 includes a grid 510, which may represent increments in longitude and latitude or some other spatial value. In some embodiments, elements 520, 530, 540 and 550 may represent mobile units (e.g., controlling units or receiving units) at locations in a wireless network, although the position of an identifiable target may be fixed at a particular location. Mobile unit 520 may operate in the controlling unit mode to identify and command mobile unit 540, and include a movement sensing circuit, a direction sensing circuit, and a location determining unit as described above. Additionally, the mobile wireless unit 520 may be aware of the locations of mobile units 530, 540 and 550 by sight, or by way of reference to a screen displaying their respective positions. For example, each of the mobile units may upload position data (e.g., determined from GPS) to a server at regular intervals. The mobile unit 520 may download the data at regular intervals to track movement of mobile units with reference to a local map including a layer showing the positions of each mobile unit 530, 540 and 550. This information may be provided as a map display or another type of graphical object.

To initiate identification of the mobile unit 540, the user of the mobile device 520 may point the direction sensor (e.g., an electronic compass) in the direction of the mobile unit 540. The heading provided by the direction sensor is shown by arrow 560. Because pointing the electronic compass toward the receiving unit may involve imprecise dead reckoning by the user, some embodiments can find and identify a mobile unit nearest to the heading. Also, consideration of candidates may be limited to an area local to the heading, for example, a sector 570 of angle (p and centered about the heading 560. In some embodiments, more than one potential candidate may be identified based on a sensed heading, for example, a heading that is near both units 550 and 540. For instance, both mobile units 550 and 540 may receive a target request from the mobile unit 520 and return target positioning information back to the mobile unit 520 (e.g., via a network server or communication links between mobile units within the local network). The mobile unit 520 may then identify the desired target by selecting either mobile unit 550 or 540 based on the position information received from these units, such as selecting a graphical position or performing movement to select from among the potential candidates.

Preferably, a digital compass may have two axes or three axes. Preferably, a three-axis magnetic compass assembly contains magnetic sensors aligned with all three orthogonal vectors, to capture the horizontal and vertical components of the earth's magnetic field. Preferably, to electronically gimbal the compass, the three magnetic sensors are complemented by a tilt-sensing element measuring the gravitational direction. The tilt sensor preferably provides two-axis measurement of the compass assembly tilt, known as pitch and roll axis. The five axes of sensor inputs are combined to create a “tilt-compensated” version of the axis magnetic vectors. Tilt-compensated vectors or orientation measurements can then be computed.

To direct the identified mobile unit 540, the user of mobile unit 520 performs a movement (e.g., a body and/or hand gesture) subsequent to movement for identifying the mobile unit 540. The mobile unit 520 interprets the subsequent movement, establishes communication with the mobile unit 540 over a wireless network (e.g., through a local network, a cellular network or other network resource) and transmits a directive or other information to the mobile unit 540. Hence, even if a mobile unit cannot view the intended recipient (e.g. the intended recipient is blocked by an obstacle), members of a local wireless network group may identify and direct that mobile unit.

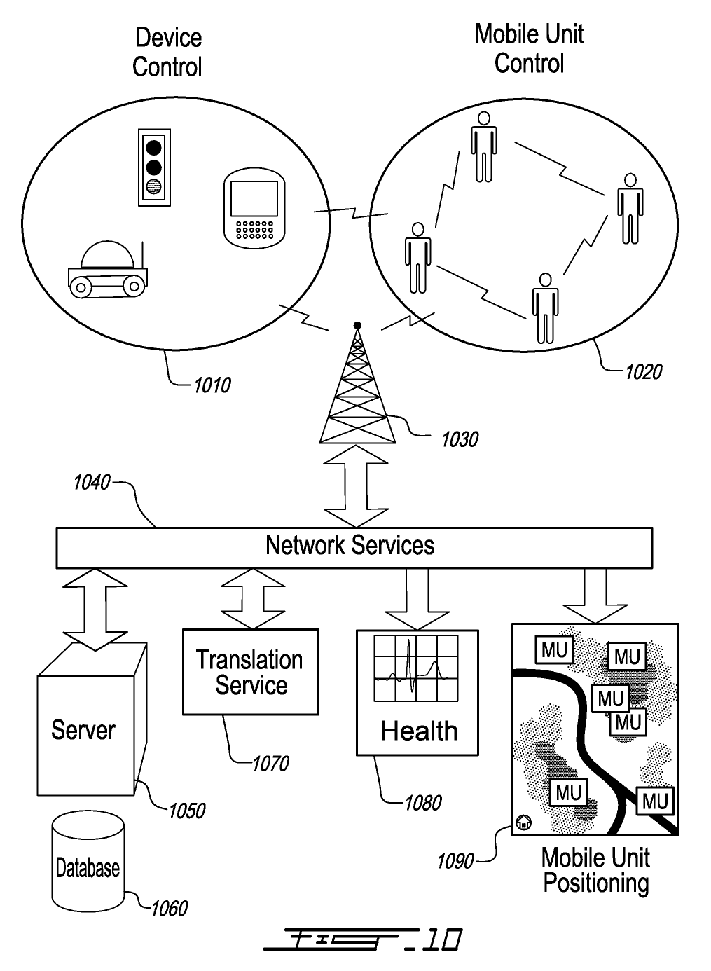

FIG. 6 is a schematic block diagram of an exemplary wireless communication system that includes a mobile unit 600. As shown in FIG. 6, the mobile unit 600 receives wireless communication signals from a cellular base station 610, GPS satellites 612, and a gesture and sensing unit 620. The cellular base station 610 may be connected to other networks (e.g., PSTN and the Internet). The mobile terminal 600 may communicate with an Ad-Hoc network 616 and/or a wireless LAN 618 using a communication protocol that may include, but is not limited to, 802.11a, 802.11b, 802.11e, 802.11g, 802.11i, Bluetooth (BT), MMAN, MANET, NWR and/or other wireless local area network protocols. The wireless LAN 618 also may be connected to other networks (e.g., the Internet).

In some embodiments of the invention, the gesture sensing unit 620 includes sensors 622-1 to 622-n , which may be one or more of an acceleration measurement sensor (e.g., accelerometer(s)), a gyroscope, bend/flex sensors, and a directional sensor 624, which is an electronic compass in this embodiment. While the embodiment of FIG. 6 depicts a plurality of sensors 622, it may include as little as one movement sensor. The sensor(s) and the electric compass 624 are connected to a controller 626, which may communicate with a processor 630 via a wired link or RF radio links. Also connected to the processor is a GPS receiver 632, a cellular transceiver 634, and local network transceiver 636 with respective antennas 633, 635 and 637, a memory 640, a health sensor 650 (e.g., pulse, body temperature, etc.), a display 660, an input interface 670 (e.g., a keypad, touch screen, microphone etc. (not shown)), and an optional speaker 680. The GPS receiver 632 can determine a location based on GPS signals that are received via an antenna 633. The local network transceiver 636 can communicate with the wireless LAN 618 and/or Ad-Hoc network 616 via antenna 637.

The memory 640 stores software that is executed by the processor 630, and may include one or more erasable programmable read-only memories (EPROM or Flash EPROM), battery backed random access memory (RAM), magnetic, optical, or other digital storage device, and may be separate from, or at least partially within, the processor 630. The processor 630 may include more than one processor, such as, for example, a general purpose processor and a digital signal processor, which may be enclosed in a common package or separate and apart from one another.

The cellular transceiver 634 typically includes both a transmitter (TX) and a receiver (RX) to allow two-way communications, but the present invention is not limited to such devices and, as used herein, a “transceiver” may include only a receiver. The mobile unit 600 may thereby communicate with the base station 610 using radio frequency signals, which may be communicated through the antenna 635. For example, the mobile unit 600 may be configured to communicate via the cellular transceiver 634 using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). Communication protocols, as used herein, may specify the information communicated, the timing, the frequency, the modulation, and/or the operations for setting-up and/or maintaining a communication connection. In some embodiments, the antennas 633 and 635 may be a single antenna.

In other embodiments, the gesture sensing unit 620 may be provided in jewelry (e.g., one or more rings, a wristwatch) or included with any type of device or package that can be attached (e.g., by adhesive, strap), worn, held or manipulated by the body.

Returning to FIG. 6, although the gesture sensing unit 620 is depicted as a wireless sensing device, it should be appreciated that in other embodiments a gesture sensing unit may be wired to a processor. For example, a gesture sensing unit may be wired to a processor located within a suit, glove, jewelry or other device or package (e.g., both the gesture sensing unit and processor may be located within a handheld device package or casing, such as a PDA), or the processor may be located remotely with respect to the gesture sensing unit and wires provided therebetween (e.g., between a mouse including a gesture sensing unit and a computer including a processor).

Additionally, embodiments of the controlling unit 110 shown in FIG. 1a may include a device having a fixed location. For example, the controlling unit 110 may be a computer located at any node in a network (e.g., a WAN, LAN or WLAN). An operator of the controlling unit 110 may identify and command one or more remote wireless targets based on viewing representations of the targets on a display (e.g., computer display, PDA display, table-top display, goggle type display). In some embodiments, movement sensing to identify and/or command a remotely deployed wireless target may involve interacting with a display, for example, a touch screen display that may be manipulated at a position corresponding to the displayed remote wireless target. In other embodiments, the reference frame of the operator's gestures sensed by the gesture sensing unit may be translated to the reference frame of the displayed remote wireless targets such that the operator is virtually located near the remote wireless targets. Hence, embodiments may include a computer operator manipulating a movement sensing unit (e.g., a glove, display, handheld device) while viewing a screen to identify and control one or more mobile and/or fixed wireless target devices deployed remotely from the operator.

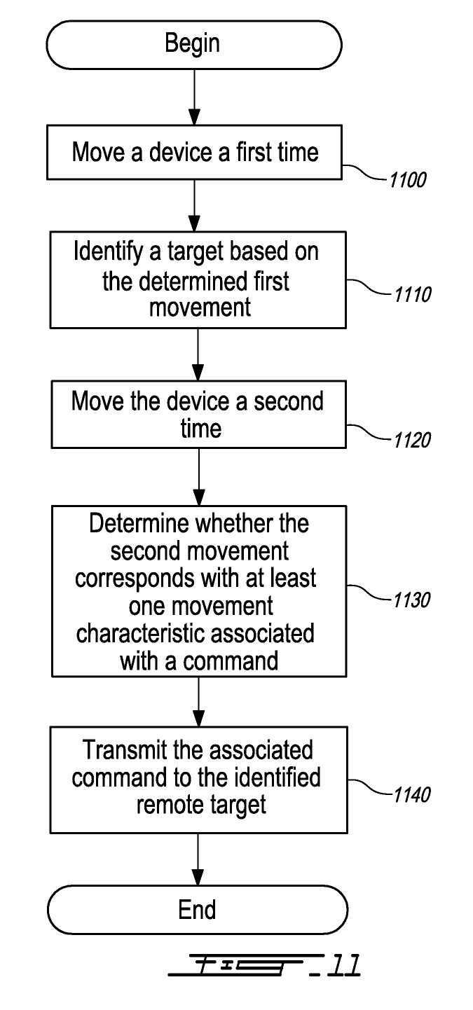

FIG. 7 shows a top view of an embodiment in which a user wears a suit, shirt, jacket or other garment 700 that includes at least one movement sensing device, such as accelerometers and/or gyroscopes. FIG. 7 also illustrates a sweep of exemplary headings extending from the shoulder of the user, which represent pointing directions that may be sensed by a direction sensor provided on the sleeve of the garment 700.

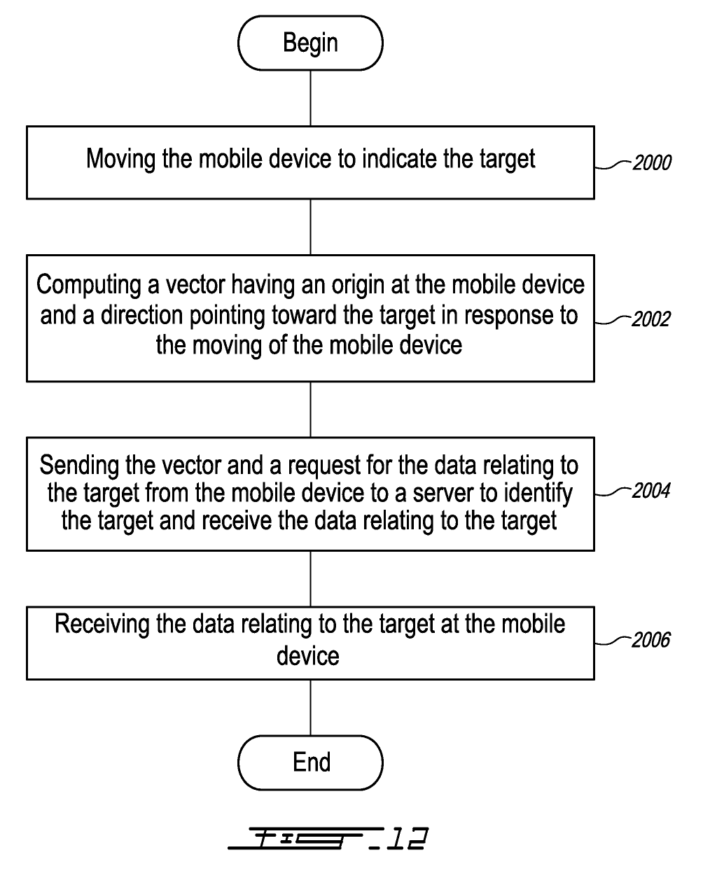

FIG. 8 is a diagram of a glove 800 in accordance with exemplary embodiments. The glove 800 corresponds to the gesture sensing unit 620 depicted in the exemplary embodiments shown in FIG. 6. The glove 800 may provide a significant increase in the granularity and amount of determinable commands of a gestural language set. For instance, a gestural language set may include “hand signals,” such as the partial list of military signals depicted in FIG. 9. The glove 800 also may be used to interpret sign languages, such as American Sign Language (ASL) and British Sign Language (BSL).

The glove 800 may include one or more movement sensors 820-1 to 820-5 provided on each finger and on the thumb to sense angular and translational movement the individual digits, groups of digits and/or the entire glove. To provide additional movement information, at least one movement sensor 820-6 may be provided on the back of the palm or elsewhere on the glove 800, although the sensors may be provided at other locations on the glove. The movement sensors 820-1 to 820-6 may include accelerometers, gyroscopes and/or flex sensors, as described above. The glove 800 also includes a direction sensing device 830, such as electric compass, which may be oriented in a manner that provides efficient of target discrimination and/or gesture detection and interpretation. Flexible links may be provided to connect the movement sensors 820-1 to 820-6 and direction sensor 830 to a controller 840, which provides serial output to an RF transmitter 850 (e.g., via BT protocol), although the output from controller 840 may be transmitted via wired or wireless link to a processor (e.g., processor 630 in FIG. 6). The sensors on the glove 800 generate signals from the movement, orientation, and positioning of the hand and the fingers in relation to the body. These signals are analyzed by a processor to find the position of the fingers and hand trajectory and to determine whether a gesture or series of gestures performed correspond with elements of the gesture language set.

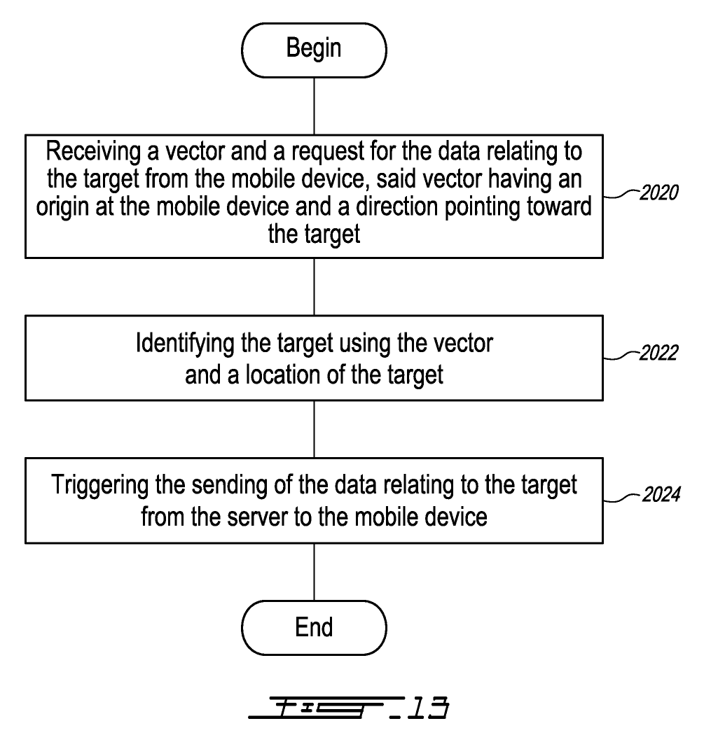

FIG. 10 is a schematic diagram illustrating network-based applications in accordance with exemplary embodiments. FIG. 10 shows an exemplary set of devices 1010 that may be identified and controlled via gesture movements, as described herein. Also shown is a set of mobile units 1020, each of which may be members of a peer-to-peer based wireless local network, such as WLAN, a Mobile Mesh Ad-Hoc network (MMAN), a Mobile Ad-Hoc network (MANET), and a Bluetooth-based network. The radio controllable devices 1010 may also communicate locally with the mobile units 1020 within the local wireless network. The devices 1010 and mobile units 1020 may have access to network services 1040 through the base station 1030.

For purposes of brevity, FIG. 10 shows a limited number of exemplary applications and network services that are possible with embodiments of the invention. These examples include server 1050 and database 1060, the devices 1010 and/or mobile units 1020 may transmit and receive information; a translation service 1070 that may provide services for map and coordinate translation (e.g., a GIS server), a health monitoring service 1080, which may track the heath of the mobile units and/or provide displayable information; and a mobile unit positioning application 1090 which tracks the position of mobile units in a local wireless network and provides a graphical view (e.g., positions displayed on a local topographical map) to the mobile units or other location(s) remote from the wireless network (e.g., a command center).

Gesture based wireless communication may be applied in a variety of ways. For instance, a police officer may remotely control traffic lights using hand and or arm gestures to change the light according to a gesture. In another embodiment, a firemen controller may receive, on display, the location of each fireman and provide individual and precise commands. Small army troops, commandos, a SWAT team, and a search and/or rescue team may deploy local wireless networks to selectively communicate among themselves or other devices connectable to the wireless network (e.g., robots or other machinery), and provide the network members with vital location data, health data and directives. Other group or team applications may include recreational strategic games, where players can deploy a local wireless network to communicate and instruct among selected players.

There are many other possible applications. Some embodiments involve selection and control of spatially fixed equipment (e.g., selecting one screen among many screens and controlling a camera associated with that screen to pan, zoom in/out etc.), adjust settings of fixed equipment (e.g., volume on a stereo, pressure in a boiler, lighting controls, security mechanisms, engine/motor rpm), and so on.

Exemplary applications also may include mobile phones or other portable devices that incorporate movement sensors, a location determining device, and a direction sensor to perform control multimedia applications. For example, the direction and directive functions of such a portable device may be interpreted as a video game console or utilized to select an icon displayed in a video presentation and activate that icon. In an embodiment, a portable device may be used to control and send commands in casino games (e.g., virtually turning a wheel or pulling a level on a screen, send commands to continue, reply etc.).

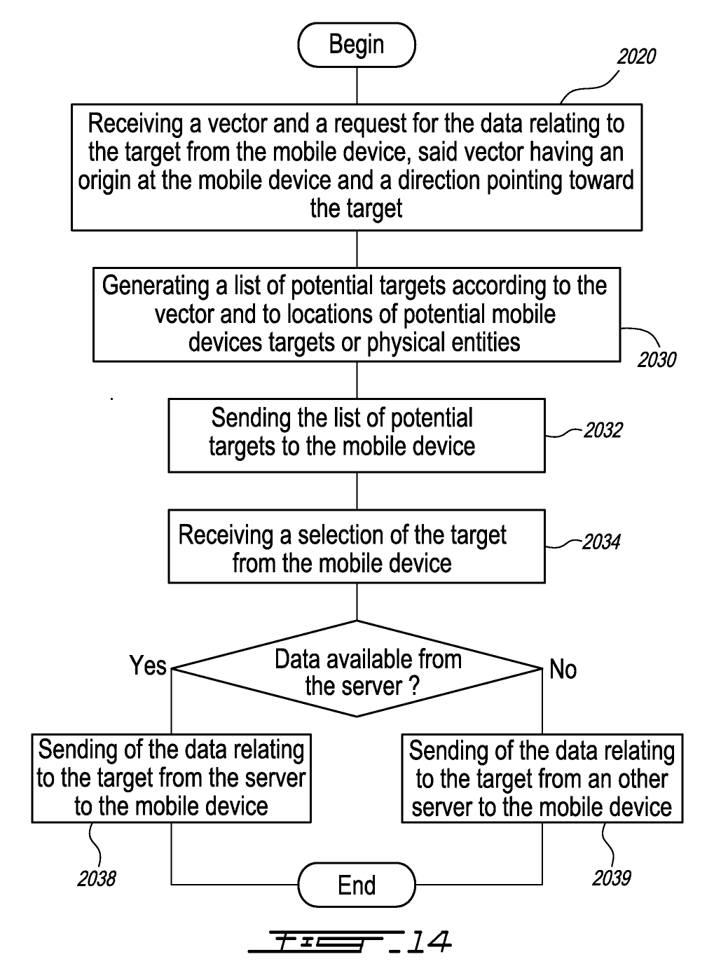

FIG. 11 is a flowchart illustrating operations for providing at least one command to a remote target according to some other embodiments. The operation begins at process block 1100 in which a device is moved a first time to identify a remote target. For example, a remote target may be identified by pointing a direction sensing device at the remote target. Some embodiments may include a determination as to whether the first movement corresponds to an identification directive. For example, it may be determined that the first movement corresponds to a pointing movement or other gesture defined in a predetermined gestural language set. In process 1110, a target is identified based on the determined first movement. The device is moved a second time in process 1120. Process 1130 determines whether the second movement corresponds with at least one movement characteristic associated with a command. If the second movement is matched or otherwise recognized to correspond with at least one movement characteristic associated with a command, the command is transmitted to the identified target in process 1140. For example, gesture samples may be stored in a database and linked to commands. Methods of recognizing gestures may include a matching algorithm that identifies a gesture when a sufficient amount of correlation between the sensed movement and stored sample data exists, or other methods such as a trained neural network. Signals relating to incidental movement or other sources of movement noise also may be filtered out to prevent activating complete gesture recognition of (e.g., walking).

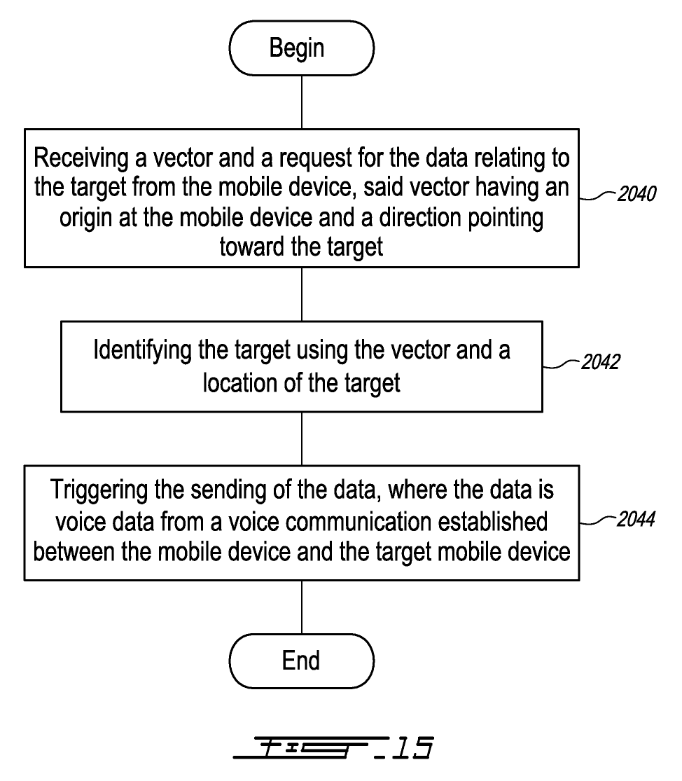

FIG. 12 illustrates a method for receiving, in a mobile unit or mobile device, data relating to a target. The method comprises the following steps. First, a user moves the mobile device to indicate the target, step 2000. The mobile device can be a cell phone, a PDA (portable digital assistant), a portable computer, a joystick, a pair of glasses, a glove, a watch, a game controller etc. Then, in response to the movement of the mobile device, the device computes a vector having an origin at the location of the mobile device and a direction pointing toward the target, step 2002. This vector and a request for the data relating to the target are then sent from the mobile device to a server, preferably in a communication network, for identifying the target and for receiving the data relating to the target, step 2004. The vector could also be calculated in another device in communication with the mobile device, such as the server. Then, the mobile device receives data relating to the target, step 2006, preferably from the server. The calculation of the vector can be done in many ways as it was explained before and will also be explained in further details below.

Many types of data relating to the target can be sent to the mobile device upon request. Examples of types of data are: information about an individual or a legal entity owning the target or a web site of an individual or legal entity owning the target. For example, an individual entity can be a person and a legal entity can be a company, the government, a municipality, public or private services, etc. Furthermore, if the target is a target mobile device, data relating to the target could contain voice data emitted and received by the target mobile device as well as the location of the target mobile device.

FIG. 13 illustrates a method for sending data relating to a target from a server to a mobile device. The method comprises the following steps. First, the server receives the vector and a request for data relating to the target from the mobile device, the vector having an origin at the location of the mobile device and a direction pointing toward the target, step 2020. Then, the server identifies the target using the vector and a location of the target, step 2022. The server has access to the location of potential targets, among which it preferably searches the best match for the vector received from the mobile device. Finally, the server triggers the sending of the data relating to the target to the mobile device, step 2024.

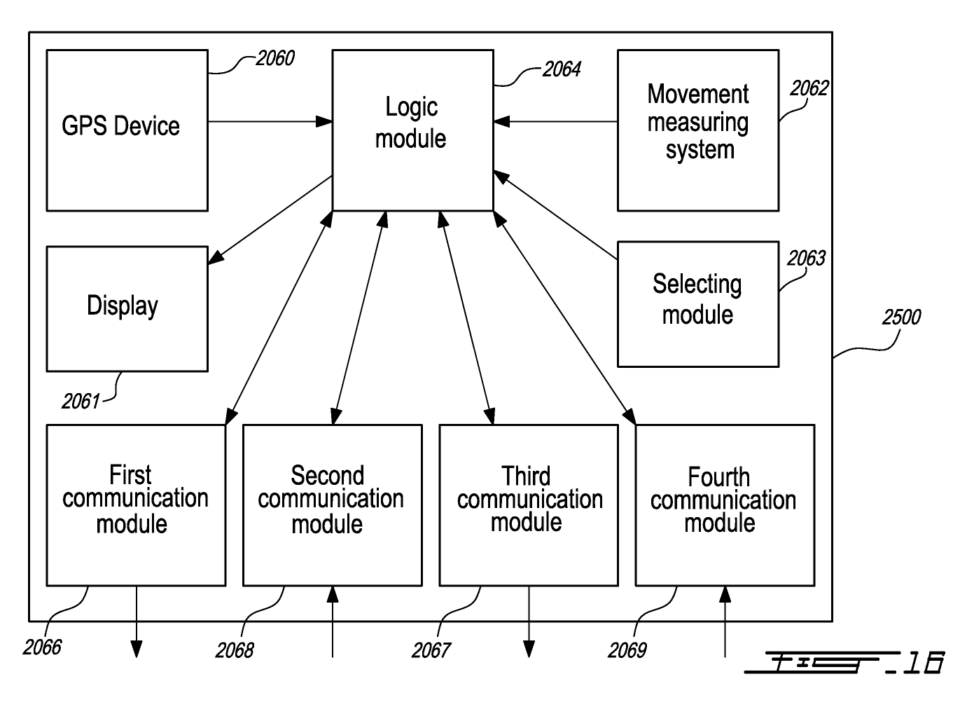

FIG. 14 illustrates the method illustrated in of FIG. 13, where steps 2022 and 2024 have been expanded. In the additional steps, the server generates a list of potential targets according to the vector and to locations of potential mobile devices targets or of physical entities, step 2030. Physical entities can be buildings, monuments, boats, planes, stars or constellations, cars, pieces of land, parks, houses, or anything that can be pointed. Then, the server sends the list of potential targets to the mobile device, step 2032, and receives in return a selection of the target from the mobile device, step 2034. This selection, in the mobile device, can be made from a list of names, addresses, phone numbers, pictures, etc., preferably displayed to a user of the mobile device. Furthermore as illustrated in FIG. 14, depending if the data requested is available from the server or not, the following step can be either to send the data relating to the target from the server to the mobile device, step 2038 or to trigger the sending of the data relating to the target form another server to the mobile device, step 2039. It can be preferable to request sending data by another server when, for example, the data consists of a voice communication held by a targeted mobile device or other data not necessarily available from the server.

Again, many types of data relating to the target can be sent from the server or from another server to the mobile device requesting them. Examples of types of data are: information about an individual or a legal entity owning the target or a web site of an individual or legal entity owning the target. For example, an individual entity can be a person and a legal entity can be a company, the government, a municipality, public or private services, etc. Furthermore, if the target is a target mobile device, data relating to the target could contain voice data emitted and received by the target mobile device as well as the location of the target mobile device.

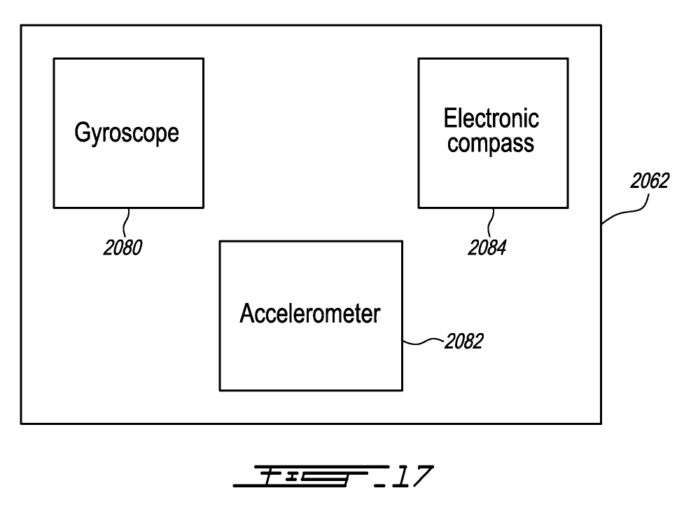

FIG. 15 illustrates a method for establishing a communication between at least two mobile devices, where a mobile device is moved to indicate a target mobile device. The method comprises the following steps. First, a server receives a vector and a request for the data relating to the target from the mobile device. The vector could be also calculated in another device in communication with the mobile device, such as the server. The vector has an origin at the location of the mobile device and a direction pointing toward a target mobile device, step 2040. Then, the server identifies the target mobile device using the vector and a location of the target mobile device, step 2042. Again, the server has access to the location of potential target mobile devices, among which it preferably searches the best match for the vector received from the mobile device. Finally, the server triggers the sending of the data, where the data is voice data from a voice communication established between the mobile device and the target mobile devices, step 2044. Step 2042 could also be expanded, as explained previously, to add the following steps. First, the server generates a list of potential target mobile devices according to the vector and to locations of potential target mobile devices. Then, the server sends the list of potential target mobile devices to the mobile device, and receives a selection of a target mobile device from the mobile device.

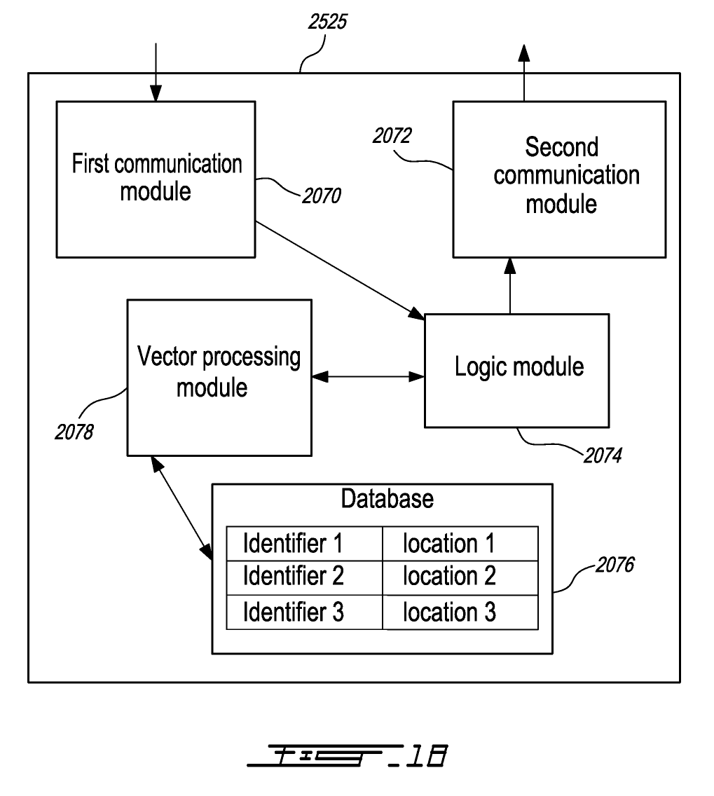

FIG. 16 illustrates components of a mobile device 2500. Preferably, the components comprise a GPS device 2060 used to detect the location of the mobile device 2500. This is not mandatory, since it is possible to locate the mobile device in different ways, such as, for example by triangulation with a cellular network. The components also comprise a movements measuring system 2062 which is used to measure movements of the mobile device 2500. The logic module 2064 is a component used to compute a vector having an origin at the location of the mobile device and a direction pointing toward a target, the vector is computed in response to movements of the mobile device. Preferably, GPS data is used as the origin of the vector. The data from other components, such as accelerometers and the gyroscope are sent to the logic module where the movement is analyzed and the direction of the vector is extracted. The mobile device also has a first communication module 2066 used to send to a server the vector for identifying a target and a request for data relating to the target. The mobile device also has a second communication module 2068 used to receive data relating to the target.

Of course, the mobile device can comprise several other components such as a third communication module to receive a list of potential targets and a display 2061 for displaying a list of potential targets to a user of the mobile device. The list of potential targets can take the form of a list of names, words, phone numbers, addresses, pictures, drawings, web pages, 3d models etc. The mobile device can further comprise a selecting module to allow the user of the mobile device to make a selection of the target, among the potential targets of the list and a fourth communication module to send the selection of the target to the server.

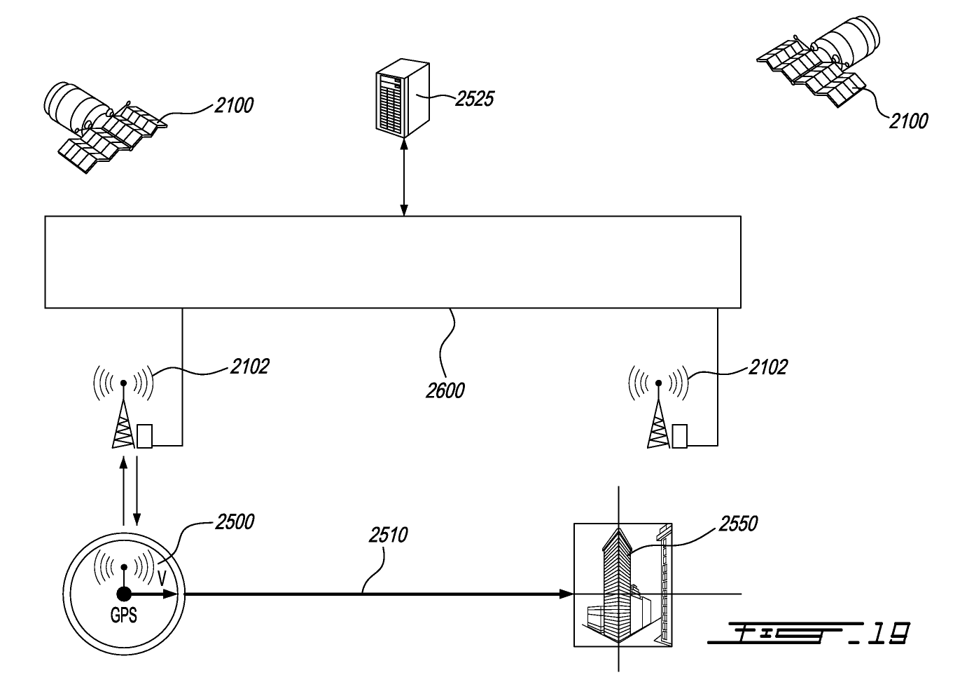

FIG. 17 illustrates several components which the measuring system 2062 can comprise such as an electronic compass 2084, an accelerometer 2082 and a gyroscope 2080. It should be understood that it is preferable to have some of these components or equivalent components, or more than one of each component, but that none are mandatory.

For example, a mobile device preferably comprising a GPS device can further have an electronic compass and three accelerometers in order to be able to compute its position in the space. However, it should be understood that this invention is intended to cover many embodiments of the mobile device, comprising different technologies and thus, should not be limited to an exemplary embodiment. Other combinations of devices, sensors or components could also provide a location and a position of the mobile device in the space.

Preferably, the data provided by the devices, sensors or components can be processed to compute at least one vector. The vector has an origin at the location of the mobile device and a direction pointing toward the target and is preferably computed from the movement made with the mobile device. Here, one vector is intended to mean one or many vectors. A single vector can be computed in some instances and many vectors could be computed if the movement made with the device is not only a movement pointing toward a target, but for example, a circle made with the device while pointing, to identify a group of targets. Many other movements could be made with the device and would result in one or a plurality of vectors.

Preferably, while processing the vector, GPS positioning information can be used to locate the mobile device and information on the heading of the device such as North, South, East and West can be computed with the data sensed from accelerometers or gyroscope sensors. The information on the heading of the device can be used to compute the direction of the vector. Other information on the movement of the device can also be extracted from the data sensed with accelerometers or gyroscope sensors. For instance, a user can point toward a single target or as described previously can make a circling movement to indicate many targets. The vector can then be transmitted, for example, over the air interface to the core mobile network by mean of any available radio access network.

FIG. 18 illustrate a server 2525. First, the server has a first communication module 2070 used to receive a vector and a request for data relating to a target from a mobile device, the vector having an origin at the mobile device and a direction pointing toward the target. The server also has a logic module 2074 receiving the vector from the first communication module and used to identify the target using the vector and a location of the target. The server 2525 also has a second communication module 2072 used to trigger the sending of the data relating to the target identified by the logic module to the mobile device. Additionally, the second communication module 2072 can trigger the sending of the data relating to the target from the server to the mobile device if the data is available in the server or trigger the sending of the data relating to the target from another server to the mobile device, if the information is not available in the server of if the information is available from one or many other components, systems or servers of the network. Of course, the server can comprise several other components such as a database 2076 comprising identifiers of potential targets and corresponding location entries and a vector processing module 2078 used for selecting the identifiers of potential targets according to the location entries of the database. In some exemplary embodiments, the server could be a game console, a computer or any other device capable of treating signals.

Furthermore, many different types of targets can be indicated using the invention. It is possible to identify fixed land marks as targets and to get information or interact with associated services available. The use of this invention in streets, while pointing to buildings or land marks is called city browsing or mix-reality technology. It enables users of mobile devices to get information corresponding to any land mark. It puts the environment into the palm of the hand by virtually allowing pointing on a wide variety of items, furniture, buildings, streets, parks, infrastructures or just anything else to get information about it.

For many years now people have been browsing information on the internet far from the original source of information. The proposed invention can bring the right information at the right time and place. With this invention, a user can get information in his mobile device just by moving it to indicate targets. Preferably, information about a city, a state or a country could be available in a street by street approach or on a location based approach and provide an efficient way to get information for users looking for about anything as, for example, shops, restaurants, hotels, museums, etc.

Furthermore, if the target is another mobile device, many other types of data can be transmitted to the mobile device requesting them. For example, voice data emitted or received by the target mobile device or the location of the target mobile device could be transmitted to the mobile device requesting them. This will be discussed further below.

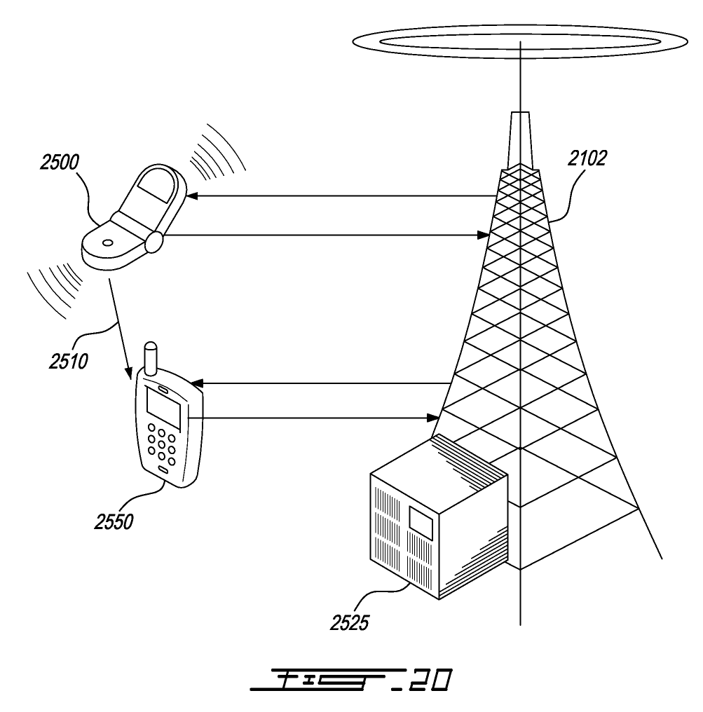

FIG. 19 illustrates an embodiment of the invention where the server 2525 is a Land Mark Server (LMS). For example, wireless network server component like a Land Mark Server could be interrogated for predefined services or information on given land marks.

Preferably, in an embodiment of the invention, the Land Mark Server could contain information in a central database for businesses, public buildings 2550, residential houses, objects, monuments, etc. based on their physical location. This information could then be available to users pointing with a mobile device 2500 toward these locations through a method described above.

Preferably, in the embodiment of the invention shown in FIG. 19, a Radio Access Network 2600 provides the air interface to communicate with the mobile device 2500 through the nodes 2102. The network 2600 is preferably used to sustain data communication over the air by means of any radio frequency technology. It also provides access to advance and basic Core Mobile Network which provides access to function like authentication, location register, billing and etc., as well as to the Land Mark Server. The Core Mobile Network routes all requests and responses to and from the Land Mark Server.

Preferably, the Land Mark Server answers requests from mobile devices asking for information, based on vectors generated by movements of the mobile device. The Land Mark Server preferably comprises a database and software for vector processing. The software calculates and identifies potential targets in the database. The Land Mark Server can provide information to the mobile device in the form of a list of targets from which the end user can choose and with which the user can interact. The list of targets can take the form of a list of names, words, phone numbers, addresses, pictures, drawings, web pages, 3d models etc. and is preferably displayed by the mobile device.

Preferably, the database can comprise a list of users, of location or any other list useful to contain information about devices, people, objects, locations, buildings, etc. Preferably, each location in the database may have a name or title and a location data entry which can be GPS based. The database can be updated when the location of the mobiles devices changes. Furthermore, each entry of the database can also refer to a web pages service or any other graphic based advertisement with which the end user could interact. Therefore, an embodiment of the invention could be used as an advertising platform for commercial land mark looking for a new way to reach their customers.

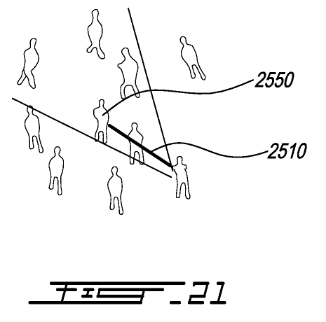

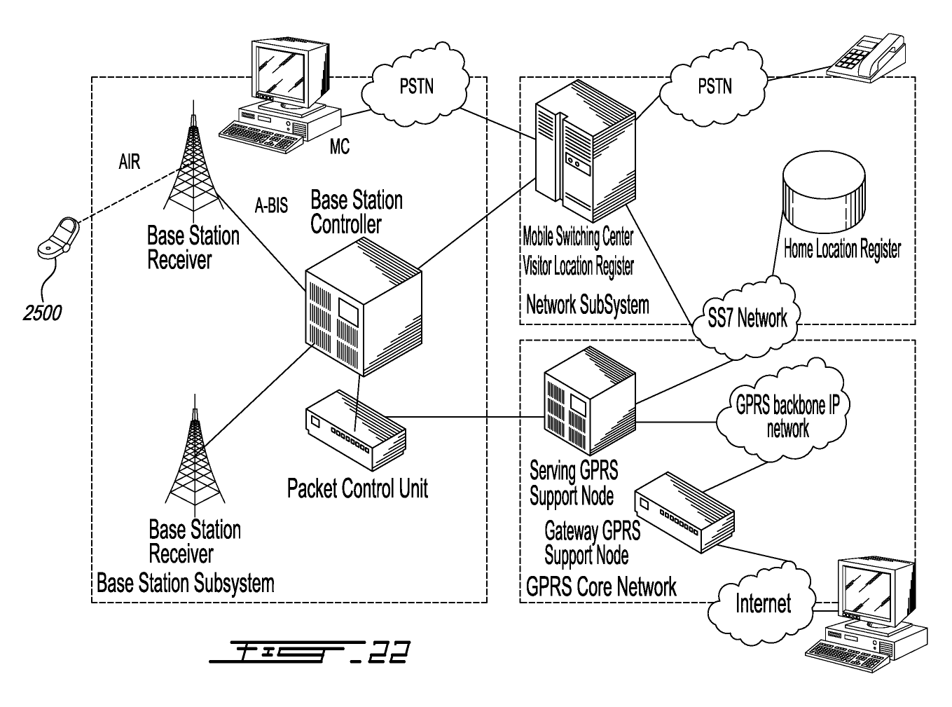

FIG. 20 and FIG. 21 illustrate an embodiment of the invention where the server is a Target Remote Monitoring Server monitoring mobile devices locations and data exchanges and where the target is a mobile device owned by a person or a company. For a decade, mobile devices have been monitored by law enforcement agency. Certain groups like gangsters and terrorists use various methods to exchange their mobile devices thus preventing being monitored. State institutions such as the police, the military and courts could use an embodiment of the invention that could provide greater protection to the public and could help preserve civil order. People identification is useful for law enforcement agencies when time comes to do monitoring. With the increase of criminal gangs, it becomes harder to track the proper persons knowing that criminals exchange mobile devices among themselves. One aspect of the present invention is to propose a new way to monitor people even though they do exchange their mobile devices, by simply pointing a mobile device toward a target.

With the present invention, a measure of a change in position and movement made by a part of the body, could be detected and measured with at least one accelerometer combined with an electronic compass and a GPS. Thus, pointing with a mobile device toward an individual having another mobile device equipped with a GPS device or a location detection device, computing a vector in the mobile device and sending this vector to a server for identification, could enable the user of the mobile device to get the user profile corresponding to the targeted mobile device. Accordingly, law enforcement personnel using a mobile device could then compare the profile received to the person targeted and holding the mobile device. Furthermore, if the targeted mobile device is not set for monitoring, it could be activated remotely to become tracked or tapped.

Preferably, the Target Remote Monitoring System (TRMS) 2525 shown in FIG.20 and FIG. 21 is a real-time monitoring system that can track individuals after their mobile device 2550 has been targeted. After pointing a mobile device 2500 toward a target 2550, a vector 2510 is calculated and transmitted to the TRMS server 2525 in the network via the node 2102. Then, the TRMS server 2525 retrieves from a database the position of all know devices in the trajectory of the vector, as shown in FIG. 21, and collects the user profiles corresponding to the devices in the trajectory of the vector 2510, to create a list. Information such as the location of the targets or the distance between the mobile device and the targets can be computed and returned to the mobile device in the form of a list for selection of the target 2550, in the case where several potential targets are identified. Once the target is selected, the mobile device transmits the selection of the target to the TRMS. Many targets could be selected as well. The TRMS can then collect all known data on the individual owning the target device, such as the name, the address, a pictures, etc. and return this information back to the mobile device, which in turn can display this information on the display of the mobile device 2500. Then, it becomes possible for the mobile device 2500 to play voice conversations having course on the targeted mobile device or to display data exchanged by the targeted mobile device.

Preferably, this TRMS can provide direct monitoring and information sharing rapidly and can send alerts or warnings if a targeted device does certain actions or operations. Examples of services that can be provided by the TRMS are: monitoring several targeted devices, providing information location, on the change of location or on the direction in which the targeted devices are moving, allowing a mobile device to access the Home Location Register or any other node in the network to collect information on the targeted mobile devices and transmit this information back to the mobile device 2500. The TRMS can calculate the movements of the targeted mobile device and predict where the targeted mobile device is going. Finally, the TRMS can issue specific commands or directives to the targeted mobile device. The TRMS should also have the ability to send scan status information to all users, in real-time, for displaying by the mobile devices.

Preferably, the mobile device 2500 includes a GPS device, an electronic compass and accelerometers. The mobile device 2500 can access the TRMS services to know get details about the targets. The mobile device can use a distance or range measuring device to provide more information for identifying the target. This could allow limiting the search by focusing at specific distances, to minimize treatment delay. The mobile device can also remotely activate the monitoring of a targeted device and receive data and voice conversation made with the targeted device.

FIG. 22 illustrates a mobile device 2500, which could also be called Mobile Station (MS) and which could be used by a law enforcement agent. Preferably, the agent enables the function for Virtual Tapping Equipment (VTE) on his mobile device that allows him to get information on the targets (mobile devices, laptop, etc.) being pointed. Based on the mobile device position and the direction in which the target is pointed, coordinates of the target can be transmitted by the network towards the Mobile Switching Center (MSC) which redirects those to the MC (Monitoring Center).

Preferably, as shown in the FIG. 21, the target is pointed by the agent and the movement forms the vector 2510. Still preferably, GPS data of the location of the mobile device of the agent, along with the vector can be transmitted towards the MC. Still preferably, the MC can then get, based on its algorithm and on interrogation of the MSC/VLR (Visitor Location Register) or HLR, the GPS locations of equipments near by the agent location.

Preferably, many targets can be found, but according to the MC algorithm only the targets or other mobile devices in the direction of the vector are treated for identification. The agent may receive information corresponding to every mobile device identified including pictures of the owners and may select one or many mobile devices to be monitored. Based on the commands and actions made by the agent, these commands shall be received by the MC which can start monitoring the selected target or targets. Other commands may include identifying the targets, selecting the potential targets to be monitored, placing the agent mobile device in a mode to receive all voice conversation/data of the monitored targeted device, blocking calls to the target device, adding or removing targeted mobile devices from the list of targeted devices to be monitored by the MC, etc. The tracking can be done on individuals carrying a mobile device or on vehicles having a GPS device or another location detecting device, for example and this invention could be useful for monitoring people during major events as Olympic Games, protesters crowding, etc. This invention could also be used for tracking people having violent compartments, being newly released from prison or having to report periodically to the police, etc.

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents that fall within the range of the claims are intended to be embraced therein.

What is claimed is:

1. A method for receiving, in a mobile device, data relating to a target, comprising the steps of:
a) moving the mobile device to indicate the target;
b) computing a vector having an origin at the mobile device and a direction pointing toward the target in response to the moving of the mobile device;
c) sending the vector and a request for the data relating to the target from the mobile device to a server to identify the target and receive the data relating to the target; and
d) receiving the data relating to the target at the mobile device.

2. The method of claim 1, wherein the data relating to the target contains information about a person owning the target.

3. The method of claim 1, wherein the data relating to the target contains information about a legal entity owning the target.

4. The method of claim 1, wherein the target is a target mobile device.

5. The method of claim 4, wherein the data relating to the target contains voice data emitted and received by the target mobile device.

6. The method of claim 4, wherein the data relating to the target mobile device contains a location of the target mobile device.

7. A method for triggering a sending of data relating to a target from a server to a mobile device, comprising the steps of:
a) receiving a vector and a request for the data relating to the target from the mobile device, said vector having an origin at the mobile device and a direction pointing toward the target;
b) identifying the target using the vector and a location of the target; and
c) triggering the sending of the data relating to the target from the server to the mobile device.

8. The method of claim 7, wherein step b) comprises the steps of:
i) generating a list of potential targets according to the vector and to locations of potential mobile devices targets;
ii) sending the list of potential targets to the mobile device; and
iii) receiving a selection of the target from the mobile device.

9. The method of claim 7, wherein step b) comprises the steps of:
i) generating a list of potential targets according to the vector and to locations of physical entities;
ii) sending the list of potential targets to the mobile device; and
iii) receiving a selection of the target from the mobile device.

10. The method of claim 7, wherein step c) further comprises sending of the data relating to the target from the server to the mobile device.

11. The method of claim 7, wherein step c) further comprises triggering the sending of the data relating to the target from an other server to the mobile device.

12. The method of claim 7, wherein the data relating to the target contains information about a person owning the target.

13. The method of claim 7, wherein the data relating to the target contains information about a legal entity owning the target.

14. The method of claim 7, wherein the target is a target mobile device.

15. The method of claim 14, wherein the data relating to the target contains voice data emitted or received by the target mobile device.

16. The method of claim 14, wherein the data relating to the target device contains a location of the target mobile device.

17. The method of claim 14, wherein the data is voice data from a voice communication established between the mobile device and the target mobile device.

18. The mobile device, comprising:
a location detecting device detecting a location of the mobile device;
a movements measuring system measuring movements of the mobile device;
a logic module computing a vector having an origin at the location of the mobile device and a direction pointing toward a target, in response to the movements of the mobile device;
a first communication module sending to a server the vector to identify the target and a request for data relating to the target; and
a second communication module receiving the data relating to the target.

19. The mobile device of claim 18 further comprising:
a third communication module receiving a list of potential targets;
a display displaying the list of potential targets;
a selecting module making a selection of the target; and
a fourth communication module sending the selection of the target to the server.

20. The mobile device of claim 18, wherein the location detecting device is a GPS (Global Positioning System) device and the movements measuring system comprises at least one of:
an electronic compass;
an accelerometer; and
a gyroscope.

21. A server comprising:
a first communication module receiving a vector and a request for data relating to a target from a mobile device, said vector having an origin at the mobile device and a direction pointing toward the target;
a logic module receiving the vector from the first communication module and identifying the target using the vector and a location of the target; and
a second communication module triggering the sending of the data relating to the target identified by the logic module to the mobile device.

22. The server of claim 21, wherein the second communication module triggers the sending of the data relating to the target from the server to the mobile device.

23. The server of claim 21, wherein the second communication module triggers the sending of the data relating to the target from another server to the mobile device.

24. The server of claim 21, wherein the server is a Land Mark Server and further comprises:
a database comprising identifiers of potential targets and corresponding location entries; and
a vector processing module selecting the identifiers of potential targets according to the location entries of the database.

25. The server of claim 21, wherein the server is a Target Remote Monitoring Server monitoring mobile devices locations and data exchanges.
